(19) United States
(12) Patent Application Publication
(10) Pub. No.: US 2022/0316805 A1
(43) Pub. Date: Oct. 6, 2022

(54) EVAPORATOR OF A WORKING FLUID FOR AN OTEC PLANT, COMPRISING IN PARTICULAR A DAMPER SYSTEM

(71) Applicant: NAVAL GROUP, Paris (FR)

(72) Inventor: Bertrand CLAUZADE, Paris (FR)

(21) Appl. No.: 17/596,708

(22) PCT Filed: Jun. 16, 2020
(86) PCT No.: PCT/EP2020/066599

§ 371 Date: Dec. 16, 2021

(30) Foreign Application Priority Data
Jun. 17, 2019 (FR) FR1906450

(51) Int. Cl. F28D 7/16; F03G 7/05; F28D 9/00; F28F 25/06

(52) U.S. Cl. CPC F28D 7/16; F03G 7/05; F28D 9/0006; F28F 25/06; F28F 2025/005

(57) ABSTRACT

The present invention relates to an evaporator of a working fluid for an OTEC plant, comprising an elongated evaporator body extending along a main axis, a bundle of evaporators transporting hot water and extending along the main axis, and a sprinkling system extending above the bundle of evaporators and suitable for sprinkling the working fluid in the liquid state onto the bundle of evaporators in order to evaporate this working fluid.

The evaporator body defines a bottom and an exhaust space for the gaseous working fluid between the bottom and the bundle of evaporators. The evaporator further comprises a damper system arranged in the exhaust space and configured to damp the drop of working fluid droplets in a non-evaporated liquid state after passing through the bundle of evaporators.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### FIELD

The present invention relates to an evaporator of a working fluid for an OTEC plant, comprising in particular a damper system.

### BACKGROUND

In a manner known per se, an Ocean Thermal Energy Conversion (OTEC) plant uses the temperature difference between the surface water and the deep water of the oceans to produce electricity.

Typically, such an OTEC plant comprises an evaporator, in which a working fluid is evaporated by the warm surface waters to drive a turbine, and a condenser, in which this working fluid is then condensed by the cold waters of the ocean floor.

The evaporator of an OTEC plant generally has an elongated body through which a bundle of evaporators extends. This bundle of evaporators, in the form of a plurality of evaporator elements, circulates hot water along the evaporator. Each evaporator element has a pipe or a plate.

A sprinkling system consisting of pipes and nozzles mounted on the pipes is provided along this bundle in order to sprinkle working fluid, in a liquid state, onto it.

The evaporator body, also known as the shell in the state of the art, not only acts as a pressurized container but also guides the working fluid evaporated by the bundle of evaporators to an evacuation system.

In horizontal falling film evaporator applications, the sprinkling system is located below the evacuation system. Thus, the fluid in liquid state, falling by gravity on the bundle of evaporators, rises again after its evaporation to the evacuation system.

As it passes through the bundle of evaporators, the non-evaporated working fluid flows from an upper evaporator element to a lower evaporator element by forming drops.

In the core of the bundle, this phenomenon does not affect the operation of the evaporator, as the drops formed are captured and evaporated by lower evaporator elements until the drops are completely evaporated.

However, the situation is different in lower layers of evaporating elements.

Indeed, while passing through these layers, at least some drops are not evaporated and the residual runoff flow impacts the bottom of the shell, which is separated from the lower layers of evaporating elements by a steam exhaust space. In particular, to provide such a space, the lower layers of evaporation elements are generally separated from the bottom of the shell by a few tens of centimeters.

Thus, the drops on the lower layers of evaporation elements have a high potential energy that is transformed into kinetic energy when the drops hit the shell.

Such an impact of the drops against the bottom of the shell leads to the dissociation of the drops into a multitude of droplets. Some of these droplets are fine enough to be carried away by the steam.

This washing away of droplets by the steam is detrimental to the proper operation of the entire power plant and the turbine in particular, located downstream of the evaporator.

In order to solve this problem, the state of the art proposes managing droplet drifting by filters, or rather, coalescence devices. These devices take the form of metal knitted fabrics, to make it possible for the steam droplets flow passing through to hit metal wires, to group together and to form drops of sufficient size to fall back by gravity.

However, the use of such a device leads to a significant pressure drop on the steam and thus reduces the efficiency of the turbine.

### SUMMARY

The object of the present invention is to propose an evaporator that avoids the formation of droplets likely to be carried away by the steam, while preserving the efficiency of the turbine and the OTEC plant, more generally.

To this end, the invention has as its object an evaporator of a working fluid for an OTEC plant, comprising:

an evaporator body of elongated shape, extending along a main axis;

a bundle of evaporators, transporting hot water and extending along the main axis;

a sprinkling system, extending over the bundle of evaporators and suitable for sprinkling the working fluid in a liquid state onto the bundle of evaporators to evaporate this working fluid;

the evaporator body defining a bottom and an exhaust space for the gaseous working fluid between the bottom and the bundle of evaporators;

the evaporator further comprising a damper system arranged in the exhaust space for the gaseous working fluid, to damp the damp the drop of working fluid droplets in the non-evaporated state after passing through the bundle of evaporators.

According to other advantageous aspects of the invention, the evaporator comprises one or more of the following features, taken alone or in any technically possible combination:

the damper system comprises a plurality of ramps, each ramp being inclined in relation to the main axis and extending between the bundle of evaporators and the bottom of the evaporator body;

in cross section perpendicular to the main axis, the bottom of the evaporator body has the shape of an arc of a circle;

each ramp forms an upper part in contact with the bundle of evaporators, an intermediate part in contact with the bottom of the evaporator body or facing it, and a lower part;

the bundle of evaporators comprises a plurality of pipes or plates extending along the main axis, a lower layer of pipes or plates being formed of pipes or plates delimiting a part of the exhaust space of the gaseous working fluid; and

the upper part of each ramp being in contact with said lower layer of pipes or plates;

the lower part of each ramp has a recess forming an opening with the bottom of the evaporator body, for the passage of the fluid in the liquid state;

the passage openings of all the ramps are aligned along the main axis forming a channel for the fluid in the liquid state;

the ramps are spaced apart so that each line perpendicular to the horizontal plane including the main axis inside the evaporator body passes through at least one ramp;

the ramps are evenly spaced apart along the main axis; and

each ramp has a shape that favors the sliding of the drops of working fluid in the non-evaporated liquid state, after passing through the bundle of evaporators towards the bottom of the evaporator body, advantageously each ramp being substantially flat.

### BRIEF DESCRIPTION OF THE DRAWINGS

These features and advantages of the invention will become apparent from the following description, given only as a non-limiting example, and made with reference to the appended drawings, on which:

FIG. 1 is a schematic side view of an evaporator according to the invention, the evaporator comprising in particular a damper system;

FIG. 2 is a schematic cross-sectional view of the evaporator in FIG. 1 according to the cross-sectional plane II-II visible in this FIG. 1;

FIG. 3 is a schematic perspective view of the damper system of FIG. 1;

FIG. 4 is a schematic side view of the damper system of FIG. 1; and

FIG. 5 is a schematic perspective view of the damper system similar to that of FIG. 3 and illustrating the operation of this damper system.

### DETAILED DESCRIPTION

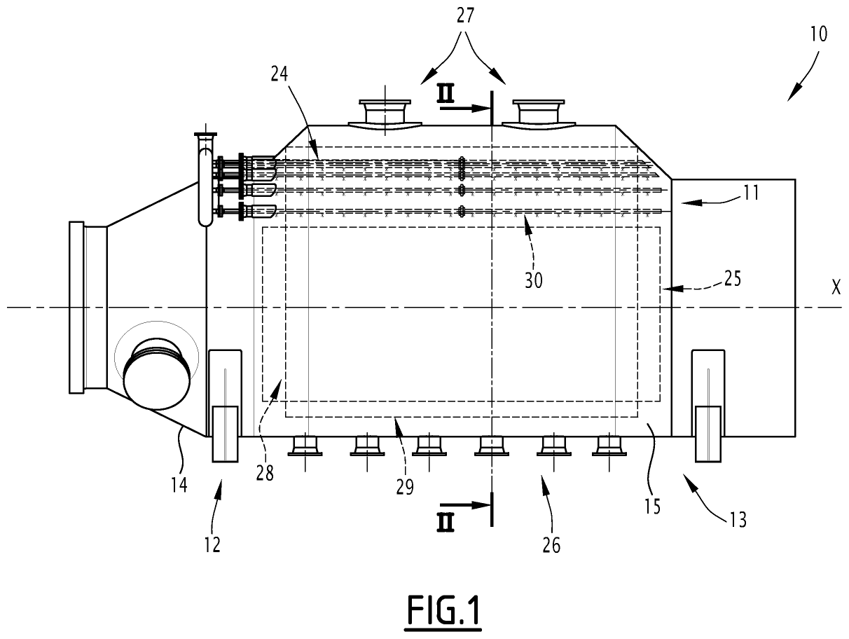

In fact, an evaporator 10 for an OTEC plant has been shown in FIG. 1. In the illustrated example, the evaporator 10 is a pipe evaporator. According to other embodiments, the evaporator is a plate evaporator.

With reference to FIG. 1, the evaporator 10 has an evaporator body 11 extended along a main axis X between a first end 12 and a second end 13.

At the first end 12, the evaporator body 11 has a substantially conical shape 14 opening into a substantially cylindrical shape 15, defining the second end 13.

The evaporator body 11 is pressurized, for example, and may also be referred to in the terminology used in the prior art as a shell.

The evaporator body 11 defines a bottom 17 corresponding to a bottom wall of this body.

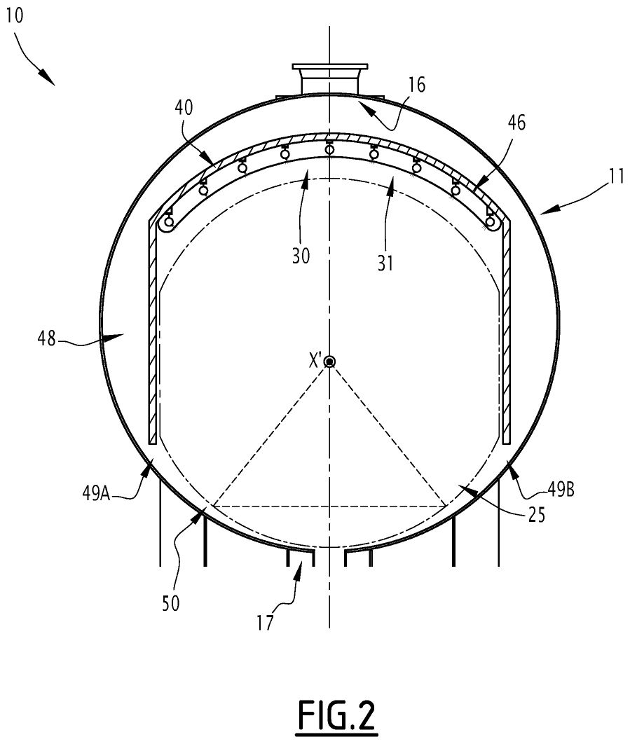

In each cross-section of the cylindrical part 15 (one of which is visible in FIG. 2), this bottom 17 has an arc of a circle with a center arranged, on the main axis X, for example. The opening of this arc is for example between 10° and 60°.

Referring again to FIG. 1, the evaporator 10 comprises a sprinkling system 24, a bundle of evaporators 25, a channeling system 26, an evacuation system 27, a guide system 28, and a damper system 29.

The sprinkling system 24 is arranged in an upper part of the evaporator body 11 and comprises a supply network and a plurality of sprinkler nozzles arranged on this supply network.

In particular, in the example of FIGS. 1 and 2, the supply network takes the form of a plurality of supply pipes 30.

Within the evaporator body 11, each supply pipe 30 extends along the main axis X above the bundle of evaporators 25. Thus, in FIG. 1, the parts of these pipes extending inside the body 11 are shown as broken lines and the parts extending outside the body 11 are shown as solid lines.

Furthermore, as can be seen in FIG. 2, in cross-section, the supply pipes 30 are arranged on an arc of a circle 31. This arc 31 is formed by suitable support means, arranged at each end 12, 13 of the evaporator body 11, for example.

The opening of this arc of a circle 31 is between 80° and 160°, for example.

In addition, the supply pipes 30 are evenly distributed along this arc, for example.

Thus, in the example shown in FIG. 2, nine supply pipes 30, distributed homogeneously along the arc 31, are shown.

The bundle of evaporators 25 takes the form of a plurality of pipes passing through the cylindrical part 15 of the body 11 along the main axis X. These pipes are a few thousand in number, for example, such as 3000 in number. Thus, for reasons of legibility of FIGS. 1 and 2, these pipes are not shown there.

The pipes of the bundle of evaporators 25 are arranged between the sprinkling system 24 and the bottom 17, and are spaced from this bottom 17 a few tens of centimeters in particular, for example.

The pipes of the bundle of evaporators 25 transport water, called warm water, i.e. surface water. This water circulates in the bundle of evaporators 25 along the main axis X, from left to right in the example of FIG. 1, for example.

Thus, when a working fluid sprinkled via the sprinkling system 24 comes into contact with the pipes of the bundle 25, it vaporizes.

The channeling system 26 allows the non-vaporized working fluid to be channeled back into the evaporator 10 via the sprinkling system 24, for example.

This channeling system 26 is arranged on the bottom 17 of the evaporator body 11 and interacts with the damper system 29, as will be explained later.

The evacuation system 27 makes it possible to evacuate steam produced by the bundle of evaporators 25 and to guide it to a (non-illustrated) turbine, for rotation.

This evacuation system 27 is arranged in the upper part of the evaporator body 11, above the sprinkling system 24 and thus above the bundle of evaporators 25.

The evacuation system 27 takes the form of a plurality of channels passing through the evaporator body 11 in the upper part thereof, for example.

The guide system 28 is used to guide the working fluid in a gaseous state to the evacuation system 27.

For this purpose, the guide system 28 comprises an elongated covers 40 extending along the main axis X. This covers the bundle of evaporators 25 and the sprinkling system 24.

The cap 40 is arranged at a distance from the inner surface of the evaporator body 11 so as to form a channel 48 for the passage of the steam to the evacuation system 27.

This channel 48 opens into the lower part of the evaporator body 11, onto two longitudinal openings 49A, 49B formed between the covers 40 and the inner interface of the evaporator body 11. Each of these openings 49A, 49B thus extends along the entire length of the covers 40 along the main axis X.

Thus, an exhaust space 50 for the gaseous working fluid is formed between the bottom 17 and the bundle of evaporators 25. In particular, after passing through the bundle of evaporators 25, the steam flow generated by this bundle passes through this space to reach the passage channel 48 via the longitudinal openings 49A, 49B.

The damper system 29 is arranged in the exhaust space 50 and is configured to damp the drop of working fluid droplets in the non-evaporated liquid state after passing through the bundle of evaporators 25.

In particular, this damper system 29 allows the kinetic energy of the non-evaporated drops to be reduced upon contact of these drops with the bottom 17.

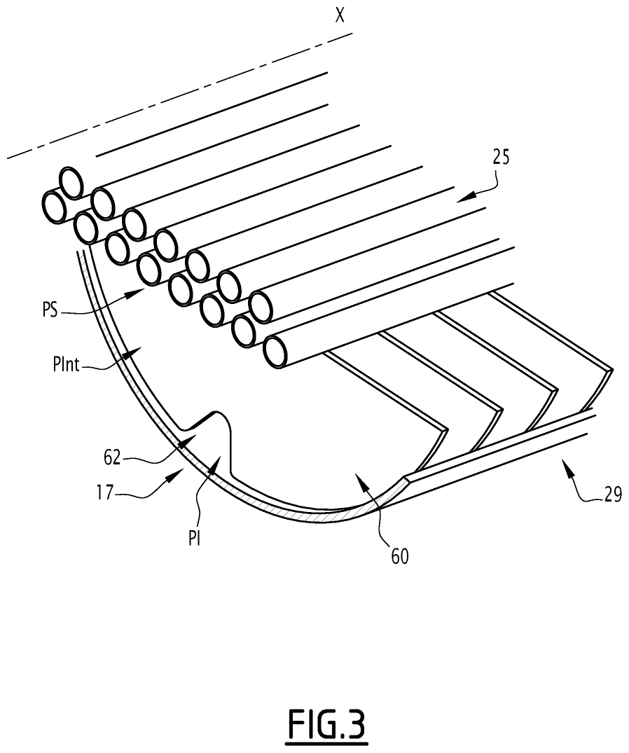

A three-dimensional view of the damper system 29 is shown in FIG. 3.

Thus, as visible FIG. 3, the damper system 29 comprises a plurality of ramps 60, with each ramp 60 inclined in relation to the main axis X and extending between the bundle of evaporators 25 and the bottom 17 of the evaporator body 11.

Each ramp 60 is planar, for example, or has any other shape that promotes sliding of the working fluid drops from the bundle of evaporators 25 to the bottom 17 of the evaporator body 11.

Thus, each ramp 60 has substantially the shape of a segment of a circle, for example, substantially conforming to the shape of the arc of the bottom 17 of the evaporator body 11.

In particular, each ramp 60 has an upper part PS, an intermediate part PInt and a lower part PI.

The upper part PS of each ramp 60 defines a straight outer contour that is in contact with the bundle of evaporators 25. In particular, this contour is in contact with a lower layer of pipes of this bundle 25. This contour is therefore perpendicular to each of these pipes.

By way of illustration, some pipes of two lower layers of the bundle 25 are shown in FIG. 3 at a scale not conforming to that of the ramps 60.

According to one example embodiment, the intermediate part PInt of each ramp 60 defines a curved outer contour, matching the shape of the arc of the bottom 17. This contour is in sealed contact with the bottom 17, for example.

According to another embodiment, the intermediate part PInt of each ramp 60 is located away from the bottom 17. This is particularly the case when the bottom 17 is flooded with a liquid other than the working fluid, such as liquid ammonia. In this case, the intermediate part PInt of each ramp 60 defines an outer contour following the shape of the arc of the bottom 17 only partially, for example, and being in contact with the surface of this other liquid. It is thus clear that in this case, the contour of the intermediate part Pint is at least partially facing the bottom 17.

The lower part PI of each ramp 60 has a recess which, with the bottom 17 of the evaporator body 11, forms an opening for passage 62 of the fluid in the liquid state.

In particular, the shape of each ramp 60 and the arrangement of the recess (and thus of the opening for passage (62) are chosen so as to promote the sliding by gravity of the drops of the liquid working fluid from the bundle of evaporators 25 towards this opening 62.

Advantageously, the openings for passage 62 of the set of ramps 60 are aligned along the main axis X, forming a channel for the fluid in the liquid state.

This channeling is then in communication with the previously explained channeling system 26, to allow channeling of the working fluid in the liquid state.

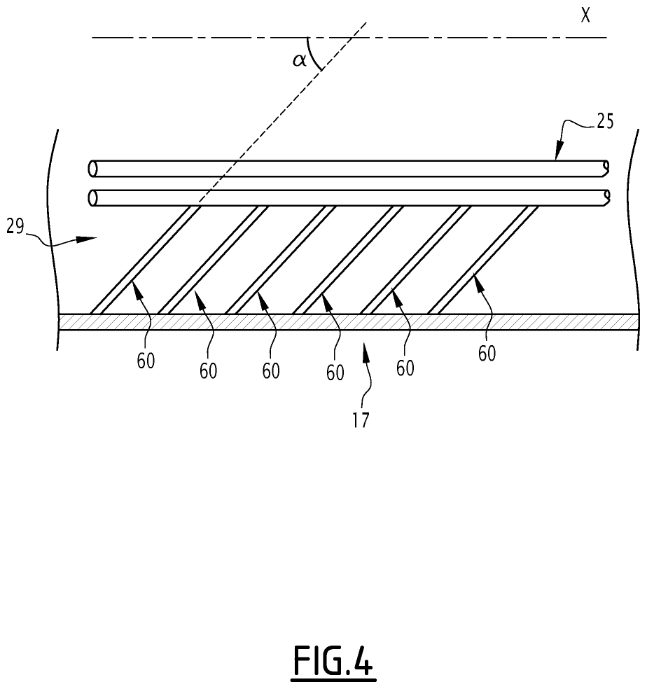

A side view of the damper system 29 is shown in FIG. 4.

Thus, in the example of this FIG. 4, the ramps 60 are inclined in relation to the main axis X and in particular in relation to the horizontal plane including this axis X, by the same angle of inclination α. The value of this angle α is between 10° and 80°, for example, advantageously between 20° and 70° and preferably between 30° and 60°.

Thus, it is clear that the ramps 60 are arranged parallel to each other in the example of FIG. 4.

Furthermore, in the same example embodiment, the ramps 60 are evenly spaced from each other along the main axis X.

However, in a general case, the ramps 60 may be arranged relative to each other in any other suitable manner.

In particular, advantageously according to the invention, the spacing distances between the ramps 60 are chosen so as to reduce the falling distance of each liquid working fluid droplet that is likely to appear on the lower layer of the pipes of the bundle of evaporators 25.

According to one embodiment, these spacing distances are chosen so that each line perpendicular to the horizontal plane including the main axis X inside the evaporator body passes through at least one ramp 60.

In other words, in this case, the distance of fall of each liquid working fluid droplet that is likely to appear on the lower layer of the pipes of the bundle of evaporators 25 is strictly lower than the distance normally separating this lower layer and the bottom 17.

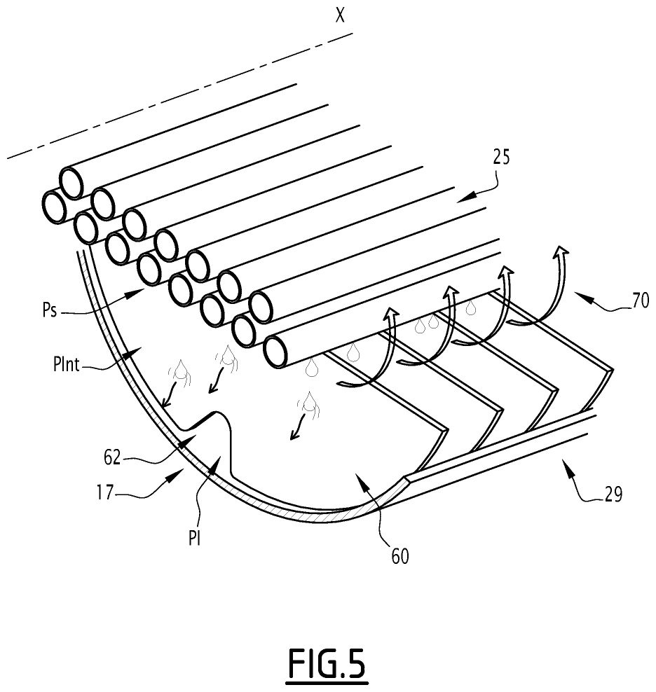

The operation of the damper system 29 is illustrated in FIG. 5,

Thus, as can be seen in this FIG. 5, when drops appear on the lower layer of the pipes of the bundle of evaporators 25 during the operation of the evaporator 10, these drops fall until they reach the corresponding ramp 60.

This reduces their kinetic energy on impact with the ramp 60 and thus prevents the appearance of fine droplets that could be carried away by the steam.

Then, the drops simply slide along the corresponding ramp 60 until they reach the passage opening 62. before being channeled by the channeling system 26.

In addition, the steam normally rises along the arrows 70, thus avoiding any pressure drop.

Thus, the damper system 29 makes it possible to dampen the fall of the drops and thus avoid the appearance of droplets and pressure losses on the steam.

Of course, the damper system 29 may be in any other suitable form that appropriately dampens the droplet fall.

1. An evaporator of a working fluid for an OTEC plant, comprising:
an elongated evaporator body, extending along a main axis;
a bundle of evaporators, transporting hot water and extending along the main axis;
a sprinkling system, extending over the bundle of evaporators and suitable for sprinkling the working fluid in a liquid state onto the bundle of evaporators to evaporate said working fluid;
the evaporator body defining a bottom and an exhaust space for the working fluid in gaseous state between the bottom and the bundle of evaporators; and
a damper system arranged in the exhaust space of the working fluid in the gaseous state and configured to damp the fall of drops of the working fluid in the non-evaporated liquid state after passing through the bundle of evaporators;
the damper system comprising a plurality of ramps, each ramp being inclined in relation to the main axis and extending between the bundle of evaporators and the bottom of the evaporator body.

2. The evaporator according to claim 1, wherein in each cross-section perpendicular to the main axis, the bottom of the evaporator body has the shape of a circular arc.

3. The evaporator according to claim 1, wherein each ramp forms an upper part in contact with the bundle of evaporators, an intermediate part (PInt) in contact with or facing the bottom of the evaporator body, and a lower part.

4. The evaporator according to claim 3, wherein:
the bundle of evaporators comprises a plurality of pipes or plates extending along the main axis, a lower layer of pipes or plates being formed of pipes or plates delimiting a part of the exhaust space of the working fluid in a gaseous state; and
the upper part of each ramp being in contact with said lower layer of pipes or plates.

5. The evaporator according to claim 3, wherein in the lower part of each ramp has a recess forming, along with the bottom of the evaporator body, an opening for passage of the fluid in the liquid state.

6. The evaporator according to claim 5, wherein the openings for passage of all the ramps are aligned along the main axis forming a channel for the fluid in the liquid state.

7. The evaporator according to claim 1, wherein the ramps are spaced apart such that each line perpendicular to a horizontal plane including the main axis within the evaporator body passes through at least one ramp.

8. The evaporator according to claim 1, wherein the ramps are evenly spaced apart along the main axis.

9. The evaporator according to claim 1, wherein each ramp has a shape favoring the working fluid drops in the non-evaporated liquid state sliding, after passage through the bundle of evaporators, towards the bottom of the evaporator body.

10. The evaporator according to claim 9, wherein each ramp is substantially flat.
